(19) United States
(12) Patent Application Publication
(10) Pub. No.: US 2025/0080612 A1
(43) Pub. Date: Mar. 6, 2025

(54) ELECTRONIC DEVICE FOR PERFORMING AVATAR MIGRATION BETWEEN METAVERSE PLATFORMS AND OPERATING METHOD OF ELECTRONIC DEVICE

(71) Applicant: ELECTRONICS AND TELECOMMUNICATIONS RESEARCH INSTITUTE, Daejeon (KR)

(72) Inventors: Wook HYUN, Sejong-si (KR); Shin Gak KANG, Sejong-si (KR)

(73) Assignee: ELECTRONICS AND TELECOMMUNICATIONS RESEARCH INSTITUTE, Daejeon (KR)

(21) Appl. No.: 18/816,635

(22) Filed: Aug. 27, 2024

(30) Foreign Application Priority Data
Aug. 29, 2023 (KR) 10-2023-0113773
Aug. 8, 2024 (KR) 10-2024-0106370

(51) Int. Cl. H04L 67/12

(52) U.S. Cl. CPC H04L 67/12

(57) ABSTRACT

An electronic device for performing avatar migration between metaverse platforms (MPs) and an operating method of the electronic device are disclosed. The operating method includes transmitting, by a first MP, first data for a first avatar registered in the first MP to a second MP that is different from the first MP and determining, by the second MP, a second avatar to be used in the second MP based on the first data.

### CROSS-REFERENCE TO RELATED APPLICATIONS

This application claims the benefit of Korean Patent Application No. 10-2023-0113773, filed on Aug. 29, 2023, and Korean Patent Application No. 10-2024-0106370, filed on Aug. 8, 2024, in the Korean Intellectual Property Office, the entire disclosure of which is incorporated herein by reference for all purposes.

### BACKGROUND

### 1. Field of the Invention

One or more embodiments relate to an electronic device for performing avatar migration between metaverse platforms (MPs) and an operating method of the electronic device.

### 2. Description of the Related Art

Currently, there are numerous metaverse platforms (MPs) around the world, but the MPs may not have interoperability capabilities in terms of an avatar, asset, content, and identity interoperability. To provide such interoperability between metaverse cross-platforms, an interoperability architecture for the metaverse cross-platforms may be necessary for common understanding among stakeholders.

### SUMMARY

According to an aspect, there is provided an operating method of an electronic device including transmitting, by a first metaverse platform (MP), first data for a first avatar registered in the first MP to a second MP that is different from the first MP and determining, by the second MP, a second avatar to be used in the second MP based on the first data.

The operating method may further include converting, by the second MP, the first data according to a policy of the second MP when the first data transmitted from the first MP to the second MP needs to be converted according to the policy of the second MP.

The operating method may further include transmitting, by the second MP, second data for the second avatar used in the second MP to the first MP and synchronizing, by the first MP, the first avatar registered in the first MP with the second avatar, based on the second data.

The first avatar may be an original avatar managed by a user to express an identity of the user in the first MP.

The second avatar may be a roaming avatar in which the first avatar is moved to the second MP and transformed according to a feature and compatibility of the second MP.

The determining of the second avatar may include determining whether the first avatar is allowed in the second MP when the first avatar is an avatar that supports synchronization in the second MP, determining the first avatar to be the second avatar when the first avatar is allowed in the second MP, and determining the second avatar by modifying the first avatar when the first avatar is not allowed in the second MP.

The determining of the second avatar may include determining whether an identifier of the first avatar is registered in the second MP when the first avatar is an avatar that does not support synchronization in the second MP and determining an avatar corresponding to the identifier of the first avatar registered in the second MP to be the second avatar when the identifier of the first avatar is registered in the second MP.

The determining of the second avatar may include determining the second avatar by changing an appearance of the first avatar in the second MP when the first avatar does not support synchronization in the second MP and an identifier of the first avatar is not registered in the second MP.

The appearance of the first avatar, which is not changed in the second MP, may be displayed visually differently and changed according to user control.

The determining of the second avatar may include determining the second avatar to be a default avatar provided by the second MP when the first avatar is not capable of being used in the second MP or a command to use another avatar in the second MP is received from a user.

According to another aspect, there is provided an electronic device including a processor and a memory configured to store at least one instruction executable by the processor, in which, the at least one instruction, when executed by the processor, causes the electronic device to transmit, by a first MP, first data for a first avatar registered in the first MP to a second MP that is different from the first MP and determine, by the second MP, a second avatar to be used in the second MP based on the first data.

The at least one instruction, when executed by the processor, may cause the electronic device to convert, by the second MP, the first data according to a policy of the second MP when the first data transmitted from the first MP to the second MP needs to be converted according to the policy of the second MP.

The at least one instruction, when executed by the processor, may cause the electronic device to transmit, by the second MP, second data for the second avatar used in the second MP to the first MP and synchronize, by the first MP, the first avatar registered in the first MP with the second avatar, based on the second data.

The first avatar may be an original avatar managed by a user to express an identity of the user in the first MP.

The second avatar may be a roaming avatar in which the first avatar is moved to the second MP and transformed according to a feature and compatibility of the second MP.

The at least one instruction, when executed by the processor, may cause the electronic device to determine whether the first avatar is allowed in the second MP when the first avatar is an avatar that supports synchronization in the second MP, determine the first avatar to be the second avatar when the first avatar is allowed in the second MP, and determine the second avatar by modifying the first avatar when the first avatar is not allowed in the second MP.

The at least one instruction, when executed by the processor, may cause the electronic device to determine whether an identifier of the first avatar is registered in the second MP when the first avatar is an avatar that does not support synchronization in the second MP and determine an avatar corresponding to the identifier of the first avatar registered in the second MP to be the second avatar when the identifier of the first avatar is registered in the second MP.

The at least one instruction, when executed by the processor, may cause the electronic device to determine the second avatar by changing an appearance of the first avatar in the second MP when the first avatar does not support synchronization in the second MP and an identifier of the first avatar is not registered in the second MP.

The at least one instruction, when executed by the processor, may cause the electronic device to determine the second avatar to be a default avatar provided by the second MP when the first avatar is not capable of being used in the second MP or a command to use another avatar in the second MP is received from a user.

Additional aspects of embodiments will be set forth in part in the description which follows and, in part, will be apparent from the description, or may be learned by practice of the disclosure.

According to embodiments, the same avatar may be used across different MPs, thereby improving presence and consistency in the online world.

According to embodiments, in general, the basic appearance and characteristics of an avatar and various customization options created by a user may be provided in a platform. That is, an avatar created by the user in one metaverse may be expressed in another metaverse in the same manner.

According to embodiments, the time, effort, and possibly money spent on creating different avatars across different platforms may be saved.

According to embodiments, the flexibility of importing an avatar created from one platform to another platform and further customizing and improving the avatar may be provided.

According to embodiments, using the same avatar across different platforms, a user may be more easily recognized and noticed by others, which may facilitate social networking across metaverses.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an architectural overview of interoperability between metaverse platforms (MPs), according to an embodiment;

FIG. 2 is a diagram illustrating an architectural overview of interoperability using a metaverse bridge, according to an embodiment;

FIG. 3 is a diagram illustrating a high-level metaverse interoperability function architecture according to an embodiment;

FIG. 4 is a diagram illustrating high-level information flow for avatar migration, according to an embodiment;

FIGS. 5 and 6 are diagrams illustrating avatar migration according to an embodiment;

FIG. 7 is a diagram illustrating an avatar type by considering cross-platform interoperability, according to an embodiment; and

FIG. 8 is a diagram illustrating an electronic device according to an embodiment.

### DETAILED DESCRIPTION

The following detailed structural or functional description is provided as an example only and various alterations and modifications may be made to the embodiments.

Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

A metaverse according to an embodiment is a compound word of meta, which refers to virtuality and transcendence, and universe, which refers to the world and the universe, and may be a three-dimensional (3D) virtual space in which the same social and/or economic utilization as in the real world is used but is not limited to the above-described embodiments. For example, the metaverse may be configured with digital entities such as a virtual asset, content, and an avatar representing a user or a machine. The virtual asset and content may be built virtually and may not depend on the real world. The metaverse may manage a real-time synchronization parameter between the physical world and the virtual world using a digital twin function. The user may operate the real world through the virtual asset synchronized with the digital twin. In general, the digital twin uses data detected by an Internet-of-Things (IoT) device, so the IoT device and the digital twin may be used in the metaverse. This type of metaverse platform (MP) may correspond to a metaverse having the digital twin because the MP uses IoT device management functionality included in the digital twin.

The user may access the metaverse with an avatar of the user and interact with other users and/or objects in the metaverse. The avatar may be a digital entity that may be used to (visually) express the user in a virtual environment. A home avatar is an avatar existing in an original MP and may be user-customized to match a corresponding entity. The primary version of the avatar in the metaverse may reside only in a certain MP or an avatar service. For example, the entity may include the user, an IoT device, a robot, a digital human, artificial intelligence (AI), a system component, etc.

According to an embodiment, the metaverse may be implemented by various service providers. The user may move the avatar used in one metaverse to another metaverse and continue their activity in the other metaverse. For this purpose, the metaverse cross-platform interoperability may be provided.

An avatar transitioning from the original MP to different MPs may potentially be changed or transformed according to a feature and compatibility of a destination MP. Herein, for ease of description, the destination MP to which the avatar registered in the original MP moves may also be referred to as a target MP.

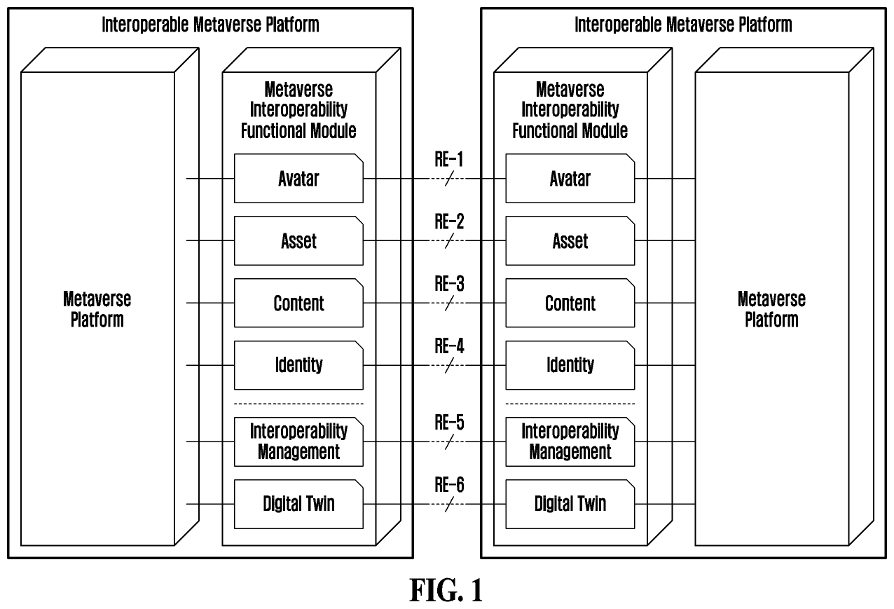

FIG. 1 is a diagram illustrating an architectural overview of interoperability between MPs, according to an embodiment.

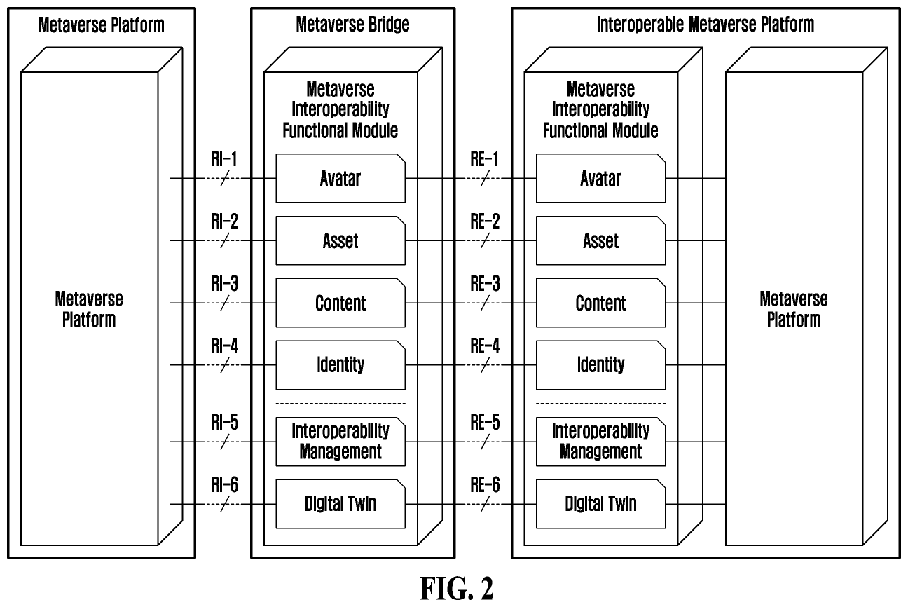

An interoperability architecture of a cross-platform metaverse may be designed to handle seamless integration and collaboration in various metaverse environments. Through this architecture, a user may seamlessly explore and interact with various virtual worlds, facilitating the integrated and interconnected metaverse experience. In addition to FIG. 1, FIG. 2 may also provide a high-level perspective on the interoperability architecture and describe a key component and functionality. The architecture may facilitate the transfer of an avatar, an asset, and user data throughout an MP, allowing the user to maintain a consistent identity and experience. The architecture may include aspects such as avatar interoperability, asset transfer mechanisms, content sharing, and identification (ID) management. There are many ways that the MP interoperates with other platforms, but the ways may be generalized to two models.

The MP may interact with other platforms using a standardized protocol, as shown in FIG. 1. As shown in FIG. 1, an interoperable MP may include an MP and a metaverse interoperability functional module (MIFM), so a reference point may not be needed. In FIG. 1, the dashed line of the MIFM may distinguish four interoperability functional components and platform-related functional components.

In FIG. 1, 3D hexahedrons, such as the MP or the MIFM, may represent functional modules, which may be defined as a collection of functional components. In addition, in FIG. 1, two-dimensional (2D) pentagons, such as an avatar, an asset, content, an identity, interoperability management, and a digital twin, may represent functional components, which may be defined as a collection of functions.

FIG. 2 is a diagram illustrating an architectural overview of interoperability using a metaverse bridge, according to an embodiment.

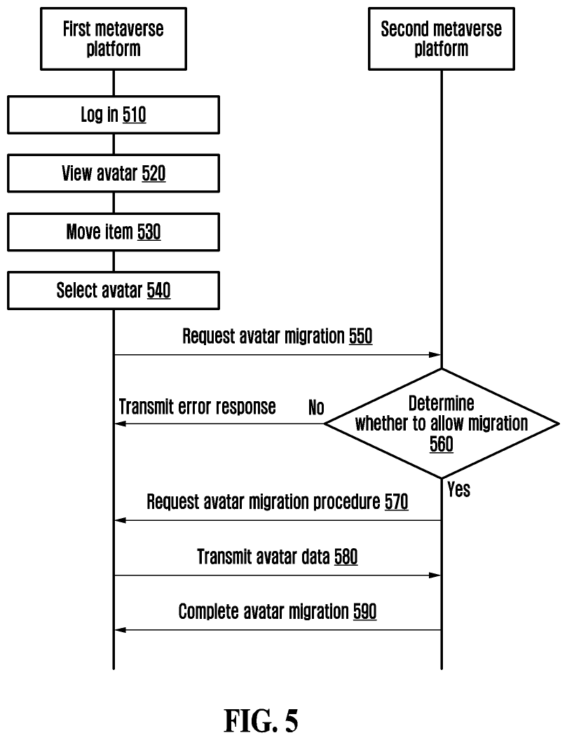

An MP may interact with other platforms using the metaverse bridge. The metaverse bridge may enable connectivity and interoperability between different MPs. A virtual bridge that allows a user, an asset, an ID, and content to seamlessly interact between different MPs may be provided. The virtual bridge does not need to be a part of a certain MP and may operate independently from the MP as a third-party service provider, as shown in FIG. 5. Since the virtual bridge is independent from the MP, each bridge service provider may easily and rapidly develop new functions and various additional services based on competitiveness. As shown in FIG. 1, the dashed line of the MIFM may distinguish four interoperability functional components and platform-related functional components.

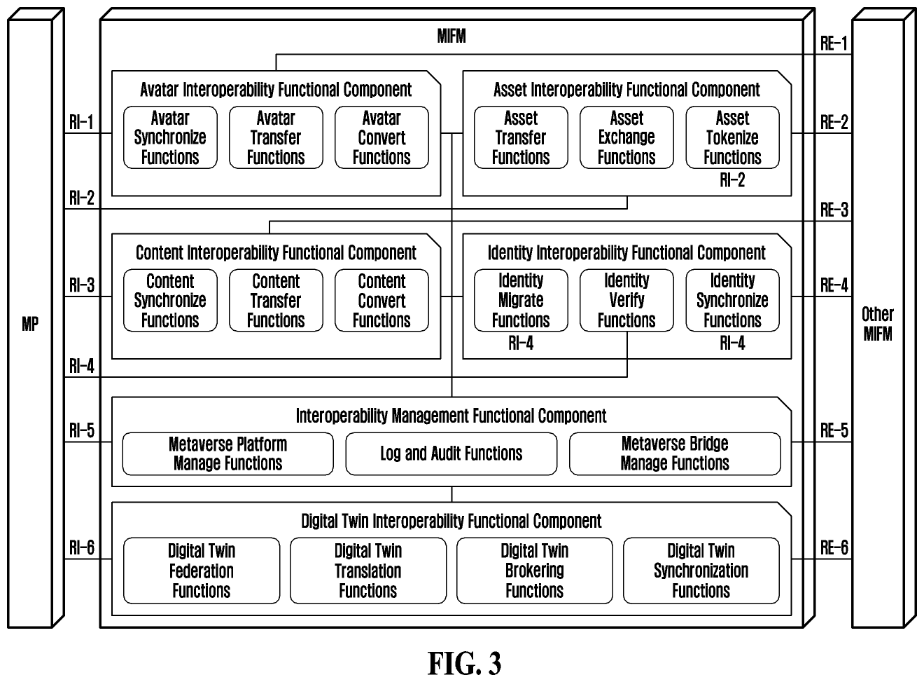

FIG. 3 is a diagram illustrating a high-level metaverse interoperability function architecture according to an embodiment.

FIG. 3 may specify an interoperability function architecture at a high level for a cross-platform metaverse and may describe related components to ensure interoperability with heterogeneous MPs. The architecture may cover an MP model that is interoperable with a metaverse bridge. However, depending on an interoperability model, each component of an MIFM may interact with other MPs through an RI reference point or an RE reference point.

The MIFM may include an avatar interoperability functional component (AVIFC), an identity interoperability functional component (IDIFC), an asset interoperability functional component (ASIFC), a content interoperability functional component (COIFC), a digital twin interoperability functional component (DTIFC), and an interoperability management functional component (IMFC). A metaverse service provider may optionally select components according to the needs for interoperability of an MP. A user may interact with the MP using an end-user device. An RI interface may be used when the MIFM is not integrated with an interoperable MP.

The AVIFC may be responsible for achieving avatar interoperability across different MPs. The AVIFC may enable seamless movement and utilization of avatars while preserving their appearance, identity, and functionality. This component may include functionalities such as avatar transfer and synchronization to ensure compatibility and consistency of avatars across platforms.

An avatar transfer function (AVTF) may enable migration of an avatar between different MPs while preserving the original characteristics of the avatar. The AVTF may manage the avatar data transfer between platforms. For example, the AVTF may support the transfer between platforms of state data, an avatar profile, accessories, control, a league, a skeleton, etc. When the avatar moves to another MP, each MP may exchange constraints during migration for compliance and performance. The AVTF may interact with an original MP and a destination MP, which import and export the avatar data through a reference point RI-1 and may interact with the AVTF through a reference point RE-1.

When a roaming avatar does not satisfy the constraints of the destination MP exchanged through an AVTF interaction of each platform, an avatar convert function (AVCF) may perform conversion on data of the roaming avatar. The conversion may also include the appearance, the accessories, and the state data. The AVCF may interact with the destination MP to obtain the policy such as avatar appearance guidance through the reference point RI-1. The AVCF may transform the avatar received from the AVTF into the destination MP and pass the avatar to the destination MP through the RI-1 reference point.

An avatar synchronize function (AVSF) may facilitate the seamless migration and activity of the avatar across different MPs. The user may import the avatar that the user creates to different platforms, and the behavior and activity of the user may be recorded in each environment. The record may be synchronized again with the original platform of the avatar, so the user may manage all their activities in one place. After roaming the avatar between MPs, a corresponding attribute may be synchronized to ensure consistency. After roaming and experiencing the avatar throughout the MP, the attribute of the avatar may be synchronized so that consistent expression of the avatar may be guaranteed throughout the MP. The AVSF may interact with a roaming MP that searches for the latest information of the roaming avatar through the reference point RI-1 and a home MP that synchronizes information through the reference point RE-1.

The IMFC may manage and facilitate the seamless interaction between different MPs and the metaverse bridges. The management may include overseeing the contract and policy that manage the relationship between these platforms.

An MP management function (MPMF) may be responsible for managing a contract between MPs. The MPMF may track the details of the contract and ensure that all parties comply with the set terms. The MPMF may include exchanging and managing a manifesto including the details of a bilateral agreement, which is a direct agreement between two platforms regarding a protocol for the interaction and data exchange. The MPMF may also oversee the policy, and code of conduct and regulatory guidelines that each platform must follow to maintain an ethical standard and compatibility throughout the metaverse.

Each MP may manage the manifesto and negotiate with other MPs using the manifesto. Through the negotiation, each MP may be able to determine whether a function is an interoperable function. When a function that is not directly compatible is required, it may be possible to request a metaverse bridge management function to resolve the problem. Each MP may include ensuring that all platforms comply with agreed norms and practices and building a safe and respected environment for the user.

The MPMF may obtain manifesto information through a reference point RI-5 by interacting with the MP and may provide information or guidance for a decision-making process for each function of the MIFM. An interoperable channel may be generated through a reference point RE-5 by interacting with the MPMF of a corresponding MIFM. The MPMF may also interact with an MBFA of the metaverse bridge to generate a bypass channel between MPs through the reference point RE-5.

A metaverse bridge management function (MBMF) may manage information of the metaverse bridge, which acts as a converter, and coordinate information and content across different MPs to be compatible, enabling seamless interaction between platforms. By interacting with the MP, the metaverse bridge may register information in the bilateral agreement or negotiation. The metaverse bridge may support interoperability between metaverses in heterogeneous platforms. The MBMF may manage a virtual bridge of the resident MIFM. That is, the MBMF of the metaverse bridge may manage all virtual bridges of multiple MIFMs, and the MBMF of the MIFM may manage only the virtual bridge.

The MPMF may interact with the MBMF and manage the virtual bridge connecting heterogeneous MPs through the reference point RE-5.

A log and audit function (LAF) may perform logging and auditing, which are important for preserving transparency and accountability. Logging may refer to a systematic recording of an event, a transaction, and an interaction, which occur between platforms. Auditing may include reviewing and inspecting logging to ensure compliance with the interoperability agreement and to identify any problems or inconsistencies that may arise. However, this may not directly store all pieces of information associated with logging and auditing. However, this may provide an interface that facilitates searching for such information from an MP itself. Through this, the latest logging and auditing data may be provided without the need to maintain a separate comprehensive database for such information. For this purpose, by providing the interface, these components may simplify the process of monitoring compliance with the interoperability agreement and policy and reviewing and analyzing an interaction between different platforms. This method may support a dynamic and efficient supervision mechanism and may access relevant data directly in real time from a source MP.

This may interact with all functions and perform logging on operational information for further auditing or inspection. However, this may not interact directly with the MP or a corresponding MIFM. The logs or all records may be accessible through an MPMF or an MBMF.

Hereinafter, a reference point of an interoperability architecture for a cross-platform metaverse is described. The reference point of the interoperability architecture may include two reference point categories, an MP-MIFM and an MIFM-MIFM. The reference point between the MP and the MIFM is described below, but this description may not specify the details of an internal functional entity of the MP.

The reference point RI-1 (MP-AVIFC) may be used for an interaction between the MP and an AVIFC of the MIFM. The reference point RI-1 may include importing and exporting avatar data between the MPs. Additional functionality facilitated by the reference point RI-1 may be as follows.

Importing Avatar Data: This may facilitate the process of integrating avatars entering a platform, ensuring that their appearance, identity, and related data (e.g., state data, profiles, accessories, control, equipment, and skeleton) are preserved.

Exporting Avatar Data: This may manage the preparation and transfer of avatar data when leaving a platform, ensuring that all related characteristics may be preserved to be used in other platforms.

Avatar Data Conversion: When an avatar does not satisfy constraints of a destination platform, the reference point RI-1 may perform conversion on avatar data (including the appearance, accessories, and state data) to satisfy these requirements.

Obtaining Policy for Avatar Transformation: This may support searching for the policy required for a transformation process, such as an avatar appearance guideline, from a destination platform.

Searching for the Latest Avatar Information: For a migrated-avatar across multiple platforms, the reference point RI-1 may support an updated information search to ensure consistent expression of an avatar.

The reference point RI-5 (MP-IMFC) may be used for an interaction between the MP and an IMFC of the MIFM for the following functions.

Searching for and Sharing Manifesto Information: This may facilitate the exchange of manifesto information, including the details of bilateral agreements, policies, and the code of conduct and regulatory guidelines between the MP and the MIFM, to ensure all parties comply with the established terms.

Providing Logging and Auditing Interface: This may support transparency and accountability by providing an interface for searching for operational information for a logging and auditing purpose from an MP.

Four reference points are described together with other MIFMs.

A reference point between AVIFCs to make an avatar interoperable is described, including the following functionality for the reference point RE-1 (AVIFC-AVIFC).

Avatar Attribute Synchronization: This may allow all changes or activities performed by an avatar across different platforms to be recorded and synchronized again to a home platform of the avatar, allowing for the unified management of the avatar experience.

Changes in Constraint and Policy: This may facilitate the exchange of information about constraints and the policies between an original platform and a destination platform to ensure compliance and optimal performance during avatar migration.

Avatar Transfer Coordination: This may coordinate the transfer of avatar data between platforms, ensuring seamless migration without loss of characteristics or functionality.

Cross-Platform Compatibility Check: This process may verify that an avatar is compatible with a technical and operational standard of a destination platform and resolve any interoperability problems that may arise.

Conflict Resolution in Avatar Synchronization: This may manage conflict resolution that may arise due to concurrent updates for an avatar state across different platforms, ensuring data integrity and consistency.

The reference point RE-5 (IMFC-IMFC) between IMFCs may support interoperability management, including the following functions.

Interoperable Channel Setting: This may enhance compatibility and cooperation between platforms by a coordinating interoperable channel generation between different MIFMs to support a protocol for the seamless interaction and data exchange between MPs.

Negotiation and Contract Management: This may facilitate contract negotiation and management across different MPs, including exchanging and updating manifesto content to reflect current and mutually agreed terms for the interaction and data exchange.

Metaverse Bridge Coordination: This may be adapted to ensure compatibility between information and content in various environments by managing an operation and information of a metaverse bridge that acts as a converter to ensure a seamless interaction between platforms. As shown in FIG. 3, the quadrangular with rounded corners, such as an avatar synchronization function, etc., may represent a function and may be defined as a collection of functionalities.

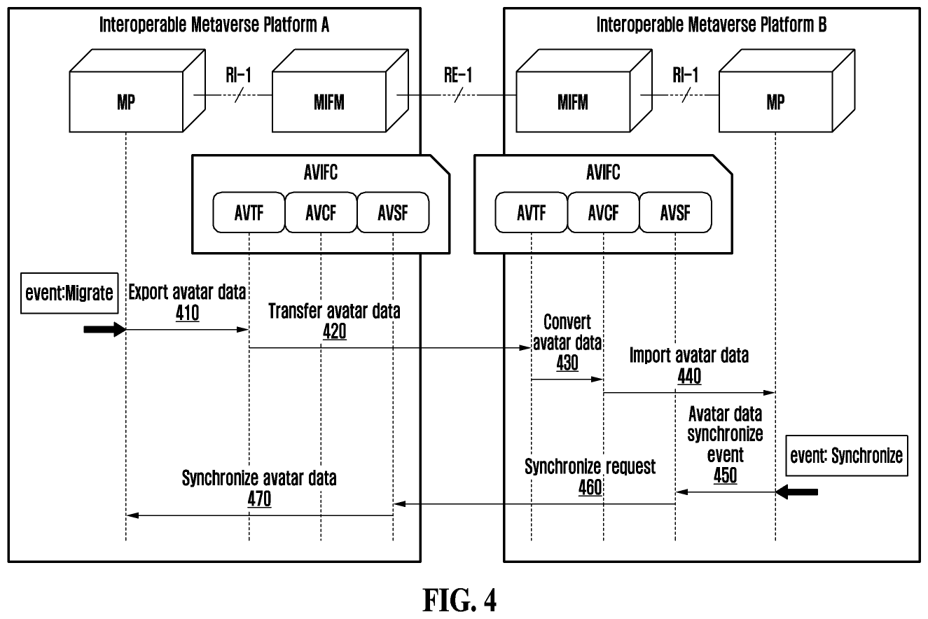

FIG. 4 is a diagram illustrating high-level information flow for avatar migration, according to an embodiment.

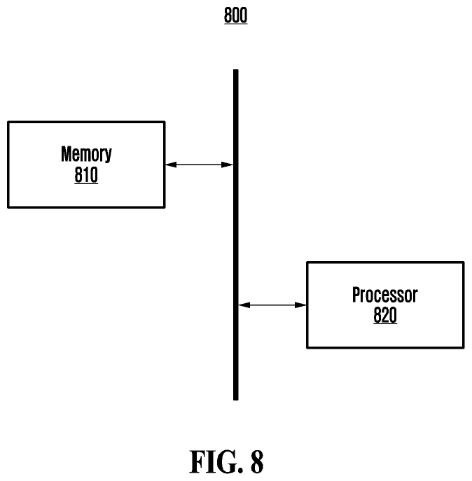

FIG. 4 illustrates an example illustrating functional components that support interoperability of an avatar, an asset, content, and an identity, and high-level information flow that supports registration of a corresponding metaverse. FIG. 4 illustrates the high-level information flow illustrating a method in which each function interacts in avatar migration. It may be assumed that both platforms establish a channel through a procedure described below with reference to FIG. 8.

In operation 410, when an avatar moves to another MP B, an MP A may export avatar data to an AVTF of an MIFM.

In operation 420, the AVTF may interact with an AVTF of an MIFM of the MP B.

In operation 430, an AVCF may perform conversion on the avatar data received from an AVTF of the MP A when conversion is required according to the MP policy of the MP B stored in an MPMF of an IMFC.

In operation 440, the MP B may import the avatar data from the AVCF.

In operation 450, when the avatar data needs to be synchronized during activity in the visiting MP B, the visiting MP B may transmit a request for the MP A to an AVSF of the MIFM.

In operation 460, the AVSF may interact with an AVSF of an MIFM in the MP A.

In operation 470, an AVSF of an MIFM in the MP A may transmit a synchronization request to the MP A.

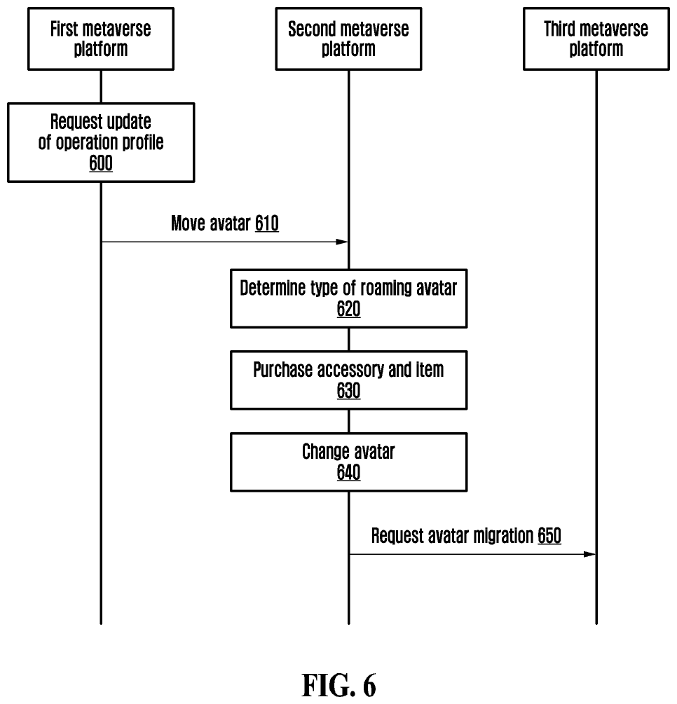

The avatar migration illustrated in FIG. 4 may be described in detail below with reference to FIGS. 5 and 6.

FIGS. 5 and 6 are diagrams illustrating avatar migration according to an embodiment.

In operation 510, a user may log in to a home MP A of the user. Herein, for ease of description, the home MP may also be referred to as an original MP.

The user may log in after being authenticated by the home MP A of the user, and an MP may generate an arbitrary session key that is globally unique and transmit the session key to the user.

The session key generated by the home MP A may be used when verifying the validity of the connection between a metaverse client and a platform or a server. The session key may correspond to a concept that is similar to the type of hypertext transfer protocol (HTTP) Cookie. The metaverse client may be installed on a device such as a personal computer (PC) or virtual reality (VR) equipment of the user.

The MP may provide information of avatars owned by the user to the user and may transmit pieces of avatar information. For example, the pieces of avatar information may include an avatar identifier, an avatar information uniform resource locator (URL), and an inventory information URL of the user. The avatar information URL may be a link that may access information, data, and files about an avatar, such as avatar metadata, avatar model files, and avatar inventories.

In operation 520, the user may select, among avatars of the user, an avatar that the user desires to use in the metaverse. When trying to access data through the avatar information URL received from operation 510, the metaverse client must provide the session key as a parameter, and here, when an incorrect session key is provided, data access may be denied. Through this, it may be possible to prevent any third party from inquiring the avatar information. When a correct session key is provided, the user may inquire the list of the avatars that the user owns and detailed information about the avatars.

In operation 530, the user may move items from an inventory of the user to an inventory of the avatar. For example, the user may freely move the items between the inventory of the user and the inventories of several other avatars. The moved items may be reported to a platform, and the movement may be reflected in a database of the platform.

In operation 540, the user may select an avatar to be used in the platform and enter the metaverse provided by the home MP A. For example, a user ID, an avatar ID, and a session ID may be required to enter the metaverse. Since the session ID is an ID granted by the platform at the time of the user's login, additional authentication may not be required. Based on the avatar ID, the user may access a digital asset in the inventory of the avatar.

In operation 550, the user may request to migrate the avatar to another MP B using a portal deployed on the MP of the user. Here, the metaverse client may transmit, to the MP B, the user ID, the avatar ID, and the session ID issued to the user from the home MP A. Here, the user ID is as an identifier of the home MP A, may include information that may be accessed from the outside, and may have a uniform resource identifier (URI) format, for example.

In operation 560, the MP B may determine whether access is possible based on reputation information about the user.

The MP B may determine whether the user ID is eligible to enter by inquiring the activity history in an existing platform (e.g., the home MP A).

In addition, the MP B may transmit code of conduct (COD) of the MP B to the home MP A and inquire the suitability of the CoD. For example, the CoD may be described in a standardized specification or a natural language. When the CoD is described in a natural language, the activity history of the user maintained in the home MP A and the suitability of the CoD of the MP B may be determined, based on AI. Additionally, for each item of the CoD, the home MP A may determine the suitability to be a value between 0 to 1 and transmit the value to the MP B, and the MP B may determine whether the user may enter based on the suitability value.

When the user is determined to have no problems in the two processes described above, the MP B may allow entry of the user. When entry is not possible, the MP B may write the reason, transmit an error response to the user, and terminate the connection with the user.

In operation 570, the MP B may notify the home MP A that the avatar is moving from the home MP A to the MP B and request an avatar migration procedure to the home MP A.

In operation 580, when it is determined that the session key is valid, the home MP A may transmit data about the avatar (e.g., avatar attribute information about a model file, an accessory, an inventory and item, an asset of the avatar, and user preference information) to the MP B. The data about the avatar may include the following information but is not limited thereto, and various pieces of information may be included without limitation.

The avatar information may include avatar basic information, avatar meta information, avatar model information, and avatar inventories.

The avatar basic information may include an avatar identifier, an avatar name, an avatar model file storage location, and whether avatar synchronization is supported. Here, the avatar name is a name for the avatar assigned by the user and may be shown to other users.

The avatar meta information may include information about the appearance and characteristics of the avatar. Since each MP may have its own 3D rendering engines, graphics technology, and an avatar modeling method, it may be more effective to share only the attribute information of the avatar and create a new avatar based on the attributes in each platform so that the avatar meta information may be transmitted between platforms. For example, the avatar meta information may include information about the appearance, skin color, hair style, clothing, etc., of the avatar.

The avatar meta information may include information required to create the avatar in the destination MP B or to maintain the appearance of the avatar equally. For example, the avatar meta information may include information about the size, color, hairstyle, clothing, and accessories.

The avatar meta information may be described as general descriptive text and may include information required to create an avatar by generative AI, such as a large language model (LLM) and a diffusion model. For example, the avatar meta information may be used to create a transformed avatar.

The avatar model information may include 3D modeling and basic information, collision information, and interactive scripts.

The 3D modeling and basic information may be a 3D model file that describes what the content looks like and what the shape and structure of the content are. For example, the 3D modeling and basic information may include a mesh, a texture, and a material, and more specifically, 3D shape data, surface mapping information, UV mapping, materials, and shading information.

The scale of a 3D model may correspond to an important factor that determines how large an object actually is. This is because the same model may operate at completely different scales across different metaverses when the scale is not standardized. Accordingly, the scale may be determined based on a real-world unit (e.g., meter). For example, the scale of the 3D model may be information about a location, a direction, a speed, a state, and the size of the avatar.

The collision information may correspond to data that defines a method in which a 3D object behaves and interacts with other objects. The collision information may include physical properties such as gravity, friction, elasticity, etc., and a collision box, collision mesh, etc., for the collision detection and response. The collision information may be information to determine whether the avatar collides with other objects. Without the collision information, the avatar may pass through other objects, or the collision may not be detected even when the avatar collides with an object.

There may be advantages to using the collision information used in the home MP A. Since the migration and interaction of the avatar remains equally in the source MP A and the destination MP B, the user may feel a familiar experience in a new environment. Since there is no need to generate or optimize the collision information, the time and resource may be saved.

When the avatar or object has unique collision characteristics, these characteristics may be maintained without any change. For example, the collision information may include the collision box in a certain shape or particular physics characteristics. When the avatar or object uses a complex collision model in the source MP A, this complex information may be used in the destination MP B, so there may be no need to reconstruct the collision model. Through the collision information, interoperability between the source metaverse and the destination metaverse may increase, and an integration between different platforms may be promoted.

However, despite these advantages, there may be limitations in using the collision information without any change due to differences in the technical requirements, optimization strategies, and physics engines of the destination MP B. Accordingly, these factors may need to be considered before importing the collision information without any change. The collision information may be converted and used according to the environment and physics engine property information of an MP, and when two-collision information values conflict, a property value of the destination MP B may be prioritized. When the collision policy of the MP conflicts with the collision policy of the avatar, the collision policy of the MP may be prioritized over the collision policy of the avatar. Otherwise, an unusual avatar (e.g., an unusual avatar with a relatively wide collision box) may enter the MP, causing great confusion in an MP system.

When the user directly provides the collision information, there may be a risk that a bug or problem may occur due to exploitation, so the MP may generate the collision information or precede verification autonomously for security and stability. When it is determined that the collision information is not suitable for use, the MP may automatically generate the collision information using a 3D model file.

The collision information of the 3D model may include a collision mesh, a collider type, a collision group and layer, and detailed information.

The collision mesh may include a simple mesh or shape information that approximates the shape of a model. The collision mesh may define the shape of the avatar or object and may be used to detect collision with other objects.

The collider type may include information specifying what type of collision inspection the collision mesh is used for. For example, the collider type may include various types such as a box collider, a sphere collider, and a mesh collider.

The collision group and layer may include information that allows the object or avatar to be allocated to the collision group and layer to detect or ignore collision with a certain object group. For example, the collision group and layer may be set to prevent a player avatar from colliding with other player avatars.

The detailed information may be information used when additional information is needed to handle a more complex collision situation. For example, the detailed information may include data that sets precision used to determine collision or that specifies an operation to be executed in the event of collision.

The relevant standard may differ for each game engine and 3D modeling tool, and the mainly used standard may be a COLLAborative design activity (COLLADA), a film box (FBX), a library, or an engine-specific format. Accordingly, it may be recommended to determine the collision information standard in a corresponding platform by referring to the document and guide of an MP or game engine being used.

The collision information of the 3D model may include the collision volume, collision tolerance, and collision handling.

A collision area is an area that collides with an avatar, an object, an environment, etc., and may be generally represented as a dot, a line, a plane, a volume, and the like. The collision tolerance may be tolerance used to determine collision. The collision handling may include information on how to handle collision when collision occurs, and may include, for example, information about which event will occur and a script (e.g., an animation script, etc.) allocated to the avatar according to the event.

The interactive script may define an interaction between avatars. The interactive script may define the behavior, reaction, event trigger, etc., of the avatar and may generally be written in a script language. The interactive script may allow that the same event, animation, reaction (e.g., facial expression, gesture, etc., for an event) to occur without any change even when the avatar of the user moves to a metaverse of a different platform.

The avatar inventory may include attributes such as items, equipment, and possessions that the avatar has and inventory information. The avatar inventory may be intended to allow the avatar to use, in the destination MP B without any change, items that the avatar has in the previous MPA. For example, the avatar inventory may include an item ID list or information, a virtual stake owned by a character, a virtual asset, land information, and the like.

The user information may include a user ID, a user preference and setting, an operation profile, a user device type and preference.

The user ID may correspond to a globally unique identifier. That is, the user ID may be uniquely determined so that the same ID is not created between users across different MPs.

The user preference and setting are preference or a personal setting set by the user in a certain metaverse, and may include, for example, a personalized control setting, an accessibility setting, and the like.

With respect to the operation profile of a user input device, the user may coordinate the avatar with various devices such as a joystick, a keyboard, a mouse, gesture voice, VR equipment, and the like. The changing of the operation method in the metaverse may affect user convenience and satisfaction. With respect to consistent experience, the user may experience the same interaction and function across different metaverses. With respect to the user convenience, since the user may use the interaction method that the user is familiar with once in multiple metaverses, the user may adapt more rapidly. When the operation method changes when the avatar moves to a new metaverse, it may be necessary to change the operation method together with the avatar transition. The operation profile may include an avatar operation method for each input device.

The operation profile may be used to define a method in which the user operates the avatar in a certain metaverse. Here, the operation method may include, for example, a method of using various input devices such as a keyboard, a mouse, a VR controller, and gesture recognition. It may be appropriate to include the operation profile in a user profile. Through this, the user may maintain the operation method setting of the user and may adjust the operation method based on a corresponding profile when transitioning the avatar.

In operation 590, the MP B may notify the user metaverse client that the avatar migration is completed. In addition, the MP B may transmit, to the user metaverse client, information about the operation method converted to suit the MP B, whether the operation method needs to be converted to suit a new metaverse so that the user may seamlessly control the avatar in the new metaverse, and a conversion method of the operation method.

Since each MP often has its own physics engine, animation system, interaction mechanism, etc., it may be difficult for the motion or behavior of the avatar to be accurately moved to another platform. In this case, to support the user to use the previously used method as much as possible by comparison-converting between the operation method profile transmitted by the user and the operation method profile of a platform, whether it is necessary to convert the operation method to suit the new metaverse so that the user may seamlessly control the avatar in the new metaverse may be transmitted to the user metaverse client.

With respect to the conversion method of the operation method, mapping may be performed between the operation profile of the user and the user character operation profile of the platform, and here, the matching operation item may follow the operation profile of the user.

In operation 600, the user metaverse client may request the update of the operation profile of the user stored in the home MP A. The operation profile requested for updating may be added to the operation profile of the user when the operation profile requested for updating is an operation method that is not in the user profile. The operation method that is not in the operation profile of the user may be added as an operation method provided by a platform. Through this, the user may move to different MPs in a way the user is familiar with. When the operation method provided by a new platform is not in the user profile, the operation method provided by the new platform may be written in the user profile, so the user may learn the new operation method in this way.

In operation 610, the user may move a selected avatar (including the avatar inventory) to another MP using a portal, etc. Here, the items in the inventory of the avatar may also be moved. The user information, the avatar information (including information of the avatar inventory), etc., may be transmitted to the home MP A.

In operation 620, the MP B, which is a roaming platform, may determine the type of roaming avatar of the user and present the user with the shape of an avatar that may be finally used to receive the selection from the user. In operation 580, when the avatar transmitted from the home MP A is a synchronization-supported avatar, a synchronized avatar may be determined. It may be determined whether the avatar (the appearance, name, etc.) is allowed in a roaming MP. For example, after the avatar and a camera may be placed in a virtual origin space and the top, bottom, left, and right appearances are captured, and then descriptive text may be generated about the shape of the avatar using AI, compliance may be checked.

When the avatar is allowed in the roaming MP, the avatar may be used in the corresponding MP.

Conversely, when the avatar is not allowed in the roaming MP, an editing function that may change the appearance of the avatar in the home MP A may be provided so that the user may modify their avatar. When the appearance of the avatar is allowed but the accessories or clothing are not allowed, the accessories may be detached from the avatar and moved to the inventory. When it is impossible to detach the accessories from the avatar, the use of the avatar may not be allowed, and the reason may be provided to the user. In this case, the intention of the user may be checked as to whether the modified avatar should be synchronized with the avatar in the home MP A or with the transformed avatar in the MP B. When the user selects synchronization, the information converted in the roaming MP may also be updated to the avatar information registered in the home MP A. When the user selects to use the modified avatar as the transformed avatar in the MP B, the transformed avatar may be determined, and the transformed appearance and attributes may be maintained only in the roaming MP.

When the avatar is not the synchronized avatar, it may be confirmed whether the avatar ID is an avatar registered in the MP B. That is, an avatar generated by moving to a platform one or more times in the past may be an avatar registered and/or stored in the MP B. When the avatar moves to the roaming MP, information of the registered roaming avatar may be loaded.

In the case of an avatar that is not synchronized or registered, the avatar may be transformed into a form that is suitable for the roaming MP. The appearance of the avatar may be automatically changed in the roaming MP. For example, when the roaming MP operates in a cartoon rendering form, but the roaming avatar is in a realistic rendering form, the avatar may be transformed into the cartoon rendering form depending on the roaming MP. When expressing blood red in the roaming MP is prohibited, the blood may be displayed in a different color. A portion that may not be automatically changed may be appropriately modified by the user. In this case, a portion that does not pass the compliance check may be displayed to induce the modification of the user.

The transformed avatar is a temporary avatar, and when the transformed avatar leaves the roaming MP, the changes may not be stored but discarded. However, when the user stores and/or registers the temporary avatar in the roaming MP, the temporary avatar may be stored as a registered roaming avatar.

When it is impossible to reflect the shape of the avatar transmitted from the home MP A or the user does not want to expose their avatar, the MP B may provide a default avatar. The default avatar is an avatar that does not reflect the characteristics of the home avatar of the user and may correspond to a basic avatar provided by a system. For example, when avatar transformation is impossible, the default avatar may be used when the user does not want to expose the characteristics of their avatar. The user may select the type and shape of the avatar provided by the MP B, but this process may be omitted according to the preference setting of the user.

In operation 630, the user may purchase accessories (e.g., items that may be mounted on the avatar), items, etc., from the roaming MP.

Items sold in the home MP A may be items that are not platform-dependent, such as a non-fungible token (NFT), or items that may only be used in a corresponding MP, and the purchased items may be stored in the inventory of the avatar of the user. However, the registered roaming avatar and the synchronized avatar may purchase items in the roaming MP.

When the purchased items are dependent items that are valid only in the roaming MP, information about the items may be stored and maintained in the MP B and may be utilized only in the MP B. Conversely, when the purchased items are not dependent in a certain MP and the synchronized avatar is used, an item global identifier, purchase authentication information, and purchased platform information may be stored and synchronized in the avatar inventory in the home MP A.

In operation 640, the user may change the shape of the avatar or attach accessories to the avatar using an avatar editing tool provided by the home MP A. When the shape of the synchronized avatar is changed or the accessories are attached, the changes may be registered in an avatar-as-a-service (AaaS) or the home MP A so that the shape of the avatar may be synchronized.

In operation 650, the avatar of the user may move from the MP B to another MP C.

When the avatar moves to the other MP C, the avatar may move based on the avatar in the home MP A.

In the case of the synchronized avatar, the operation performed on the synchronized avatar in the existing MP B may be performed on the MP C in the same manner. That is, avatar interworking may be performed between the home MP A and the MP C.

When the avatar is not the synchronized avatar, the changes in the shape of the avatar that occurred in the MP B and the items that are dependent in the MP B may not be moved to the MP C. That is, the changes in the shape of the avatar performed on the MP B may be valid only in the MP B. However, when accessing the MP B again, when the avatar is the registered roaming avatar, the existing changes or the dependent items in the MP B may all be used without any change.

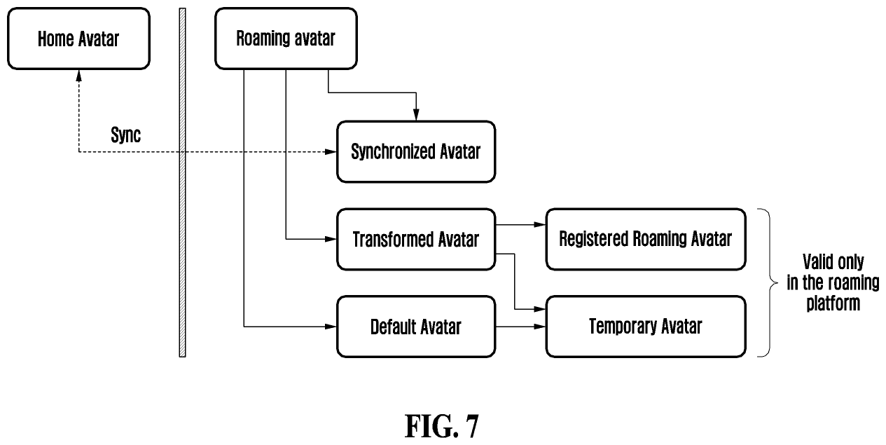

FIG. 7 is a diagram illustrating an avatar type by considering cross-platform interoperability, according to an embodiment.

FIG. 7 describes requirements for interoperability across MPs. General requirements for platform interoperability may be as follows.

It may be recommended that an MP provide an interface that may negotiate the capabilities of each platform. It may be recommended that a metaverse bridge provide an interface to support interoperability across heterogeneous platforms. In the entire platform-to-platform data transmission, a robust authentication mechanism may have to be used to ensure data integrity. It may be recommended that all pieces of data transmitted between platforms be protected through end-to-end encryption. FIG. 7 may represent the type of avatar by considering cross-platform interoperability. A home avatar is an original avatar managed by a user to express an identity of the user and may be user-defined by the user in an original MP. In the metaverse, the primary version of the user digital expression may reside only in a certain MP or an avatar service. When the home avatar moves to another MP, the home avatar may become a roaming avatar. The roaming avatar is a transitioning avatar from the original MP to a visited MP and may potentially undergo changes or variations according to a feature and compatibility of a destination platform.

The home avatar is an avatar belonging to a certain platform and may be, for example, an avatar belonging to a separate avatar service provider in the form of AaaS. The home avatar is decentralized, and the shape of the avatar may be written in a blockchain or may be created, maintained, and managed by a client of the user.

The roaming avatar may represent an avatar in which the home avatar moves to another MP. The type of roaming avatar may include a synchronized avatar, a transformed avatar, a registered roaming avatar, a temporary avatar, and a default avatar.

Synchronized Avatar: The roaming avatar may maintain uniformity throughout the MP, perform mirroring on the appearance and attributes of the home avatar, and be seamlessly interchanged across platforms. The roaming avatar may maintain consistency in various environments through a synchronization protocol or a standard, so there may be an unchanged expression regardless of the metaverse the user explores.

The synchronized avatar may be synchronized between different metaverses. This may indicate that the appearance and function of the avatar remain equally across each metaverse. The synchronized avatar may be frequently used in the virtual world or game where the user wants to maintain a consistent identity.

Transformed Avatar: The roaming avatar may be changed or coordinated to suit a certain MP. Changes may be caused by compatibility issues unique or requirements and features of a target MP.

The transformed avatar may be an avatar that transforms the appearance or function of the avatar when moving from one metaverse to another metaverse. The transformed avatar may be used to provide a more natural migration experience to the user.

Registered Roaming Avatar: The registered roaming avatar may be a roaming avatar that is registered to an MP after the user visits the MP at a time. The registered roaming avatar may be a transformed avatar or a customized avatar that the user creates in a platform. The registered roaming avatar may be used again when the user visits the platform again.

Temporary Avatar: The temporary avatar may be a roaming avatar that is temporarily used when moving to another MP. The temporary avatar may be a default avatar or a transformed avatar that has no connection with the home avatar of the user. The temporary avatar may be discarded or replaced when the user leaves the platform.

Default Avatar: The default avatar may be a roaming avatar provided by an MP for the user who does not customize their roaming avatar or for a case in which the roaming avatar is incompatible. The default avatar is an avatar that may be used across all metaverses, have limitations on the appearance or functionality, and be used to increase compatibility between metaverses.

The synchronized avatar may be the same as the home avatar and be synchronized. The transformed avatar may be a modified version of the home avatar by a target platform. The default avatar is a default avatar provided by the target platform and may not reflect the identity of the user. The transformed avatar may be registered in the target platform for reuse on the next visit. When the transformed avatar is not stored, the temporary avatar may be used when the user withdrawals.

The identity of the avatar in the MP may be the same as or bound to the identity of a corresponding external entity. Requirements for avatar interoperability may be as follows.

A visiting MP may need to provide the default avatar in case the home avatar is not compatible with the roaming avatar in the visiting MP. It may be recommended to use a unified format, such as a virtual reality model (VRM) format, for avatar expression to exchange an avatar model file between MPs.

Requirements for the appearance of the avatar may be as follows. The requirements may be used to specify a protocol specification for avatar migration and management.

It may be recommended to maintain the appearance of the avatar equally across different MPs. Depending on the policy of a target metaverse, the modification of the appearance of the avatar may be optionally supported by other MPs. Depending on the policy of the target metaverse, changes in the appearance of the avatar may be optionally deleted or maintained during roaming. When the roaming MP may maintain information about the roaming avatar, the roaming MP should be able to restore the appearance of the avatar that is previously used upon revisiting. When the avatar migrates to another platform, the clothing and accessories of the avatar may need to be moved. It may be recommended that the target MP provide a list of supported avatar functions. It may be recommended that the target MP provide a modified avatar generated based on the intersection of these features with the characteristics of the home avatar. It may be recommended that the default avatar be customizable by the user in the constraints of the target MP.

Avatar migration and negotiation requirements may be as follows. These requirements may be used to specify a protocol specification related to a migration procedure.

It may be recommended to actively exchange constraints such as the number of polygons in avatars, given the impact on performance. An error message may need to be transmitted with an explicit reason when the roaming avatar is not allowed in the target metaverse. It may be recommended to facilitate avatar migration through a cross-platform application programming interface (API) that integrates with multiple platforms.

Avatar migration and negotiation requirements may be as follows. These requirements may be used to specify a protocol specification related to an avatar synchronization procedure.

Considering the impact on performance, it may be recommended to actively exchange constraints such as the number of polygons in avatars. When the roaming avatar is not allowed in the target metaverse, an error message with an explicit reason may need to be transmitted. It may be recommended to facilitate avatar migration through a cross-platform API that integrates with multiple platforms.

Avatar migration and negotiation requirements may be as follows. These requirements may be used to specify a protocol specification related to a synchronization procedure.

For a platform that supports the synchronized avatar, the user may need to synchronize their home avatar whenever the user changes the appearance of the roaming avatar or replaces accessories, clothing, etc. Home avatar information, including an avatar model, the owner, metadata, etc., may need to be stored and maintained in a remotely accessible location. The information may be stored in the home MP, an avatar service platform, a distributed user terminal, a blockchain, etc. Accessories and clothing may need to be attached to the avatar when the avatar moves to another platform. It may be recommended to configure a database to store information about the home avatar for real time synchronization across platforms.

Avatar delegation requirements may be as follows. These requirements may be used to specify a protocol specification for an avatar delegation procedure.

When the user is not in an online state, the operations of the avatar may be optionally delegated to a third party such as an AI service provider. It may also be possible to support an AI avatar in a certain MP.

The type of avatar affiliation may include an AaaS and a home metaverse. In the case of an AasS type, user authentication, avatar management, inventory management, etc., may be supported as an independent service system and/or provider that is independent from an MP. In this case, the user may use an avatar registered in their AasS no matter what metaverse the user accesses. However, this may be under the assumption that the MP is capable of interworking with the AaaS through bilateral agreements.

The type of home metaverse is an avatar belonging to a certain metaverse, and original information of all pieces of information, such as an avatar attribute value, a model file, etc., may be managed by the home metaverse. That is, the MP may autonomously support the role of the AaaS.

An avatar model storage location may include a centralized server (an avatar service provider), a distributed storage or a user client (decentralized), and a metaverse-only (affiliated) avatar (home metaverse).

In the case of the centralized server (the avatar service provider), avatar information may be stored in the centralized server or a database, and each MP may request and read the information as needed. This method may allow the user to import the information of the avatar by transmitting a request to the centralized server whenever the user moves across MPs. In this case, the avatar information may be managed by the centralized server, and each platform may request the avatar information from the server.

In the case of the distributed storage or the user client (decentralized), avatar information may be stored in the distributed storage or the client of the user. Whenever the user moves across the MPs, the client of the user may transmit the avatar information to a new platform. In this case, the avatar information may be managed by the distributed storage such as the client of the user or a blockchain, and a new platform may receive the avatar information from the client of the user and read a file from the distributed storage.

In the case of the metaverse-only (affiliated) avatar (home metaverse), a certain function and feature of each platform and the user experience may be optimized. The metaverse-only avatar may be responsible for storing the avatar and distributing the avatar when the avatar moves in an MP.

Herein, the user may be a concept including both a real person and a metaverse client. The metaverse client may be installed on a device such as a PC or VR equipment of the user.

FIG. 8 is a diagram illustrating an electronic device according to an embodiment.

Referring to FIG. 8, an electronic device 800 according to an embodiment may include a memory 810 and a processor 820. The memory 810 and the processor 820 may communicate with each other via a bus.

The memory 810 may include a computer-readable instruction. When an instruction stored in the memory 810 is implemented by the processor 820, the processor 820 may perform the operations described above. The memory 810 may be a volatile memory or a non-volatile memory.

The processor 820 may be a device that executes instructions or programs or controls the electronic device 800 and may include, for example, a central processing unit (CPU), a graphics processing unit (GPU), or the like. The electronic device 800 may be connected to an external device (e.g., a PC or a network) through an input and output device (not shown) to exchange data therewith. The electronic device 800 may be implemented as various computing devices, such as a smartphone, a tablet, a laptop, and a PC, various wearable devices, such as a smart watch and smart glasses, various home appliances, such as a smart speaker, a smart TV, and a smart refrigerator, a smart car, a smart kiosk, and an Internet of things (IoT) device, or as a part thereof.

The processor 820 may transmit, by a first MP, first data for a first avatar registered in the first MP to a second MP that is different from the first MP and determine, by the second MP, a second avatar to be used in the second MP based on the first data.

In addition, the electronic device 800 may process the operations described above.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. An operating method of an electronic device, the operating method comprising:
transmitting, by a first metaverse platform (MP), first data for a first avatar registered in the first MP to a second MP that is different from the first MP; and
determining, by the second MP, a second avatar to be used in the second MP based on the first data.

2. The operating method of claim 1, further comprising:
converting, by the second MP, the first data according to a policy of the second MP when the first data transmitted from the first MP to the second MP needs to be converted according to the policy of the second MP.

3. The operating method of claim 1, further comprising:
transmitting, by the second MP, second data for the second avatar used in the second MP to the first MP; and
synchronizing, by the first MP, the first avatar registered in the first MP with the second avatar, based on the second data.

4. The operating method of claim 1, wherein the first avatar is an original avatar managed by a user to express an identity of the user in the first MP.

5. The operating method of claim 1, wherein the second avatar is a roaming avatar in which the first avatar is moved to the second MP and transformed according to a feature and compatibility of the second MP.

6. The operating method of claim 1, wherein the determining of the second avatar comprises:
determining whether the first avatar is allowed in the second MP when the first avatar is an avatar that supports synchronization in the second MP;
determining the first avatar to be the second avatar when the first avatar is allowed in the second MP; and
determining the second avatar by modifying the first avatar when the first avatar is not allowed in the second MP.

7. The operating method of claim 1, wherein the determining of the second avatar comprises:
determining whether an identifier of the first avatar is registered in the second MP when the first avatar is an avatar that does not support synchronization in the second MP; and
determining an avatar corresponding to the identifier of the first avatar registered in the second MP to be the second avatar when the identifier of the first avatar is registered in the second MP.

8. The operating method of claim 1, wherein the determining of the second avatar comprises determining the second avatar by changing an appearance of the first avatar in the second MP when the first avatar does not support synchronization in the second MP and an identifier of the first avatar is not registered in the second MP.

9. The operating method of claim 8, wherein the appearance of the first avatar, which is not changed in the second MP, is displayed visually differently and changed according to user control.

10. The operating method of claim 1, wherein the determining of the second avatar comprises determining the second avatar to be a default avatar provided by the second MP when the first avatar is not capable of being used in the second MP or a command to use another avatar in the second MP is received from a user.

11. A non-transitory computer-readable storage medium storing instructions that, when executed by a processor, cause the processor to perform the operating method of claim 1.

12. An electronic device comprising:
a processor; and
a memory configured to store at least one instruction executable by the processor,
wherein, the at least one instruction, when executed by the processor, causes the electronic device to:
transmit, by a first metaverse platform (MP), first data for a first avatar registered in the first MP to a second MP that is different from the first MP; and
determine, by the second MP, a second avatar to be used in the second MP based on the first data.

13. The electronic device of claim 12, wherein, the at least one instruction, when executed by the processor, causes the electronic device to convert, by the second MP, the first data according to a policy of the second MP when the first data transmitted from the first MP to the second MP needs to be converted according to the policy of the second MP.

14. The electronic device of claim 12, wherein, the at least one instruction, when executed by the processor, causes the electronic device to:
transmit, by the second MP, second data for the second avatar used in the second MP to the first MP; and
synchronize, by the first MP, the first avatar registered in the first MP with the second avatar, based on the second data.

15. The electronic device of claim 12, wherein the first avatar is an original avatar managed by a user to express an identity of the user in the first MP.

16. The electronic device of claim 12, wherein the second avatar is a roaming avatar in which the first avatar is moved to the second MP and transformed according to a feature and compatibility of the second MP.

17. The electronic device of claim 12, wherein, the at least one instruction, when executed by the processor, causes the electronic device to:
determine whether the first avatar is allowed in the second MP when the first avatar is an avatar that supports synchronization in the second MP;
determine the first avatar to be the second avatar when the first avatar is allowed in the second MP; and
determine the second avatar by modifying the first avatar when the first avatar is not allowed in the second MP.

18. The electronic device of claim 12, wherein, the at least one instruction, when executed by the processor, causes the electronic device to:
determine whether an identifier of the first avatar is registered in the second MP when the first avatar is an avatar that does not support synchronization in the second MP; and
determine an avatar corresponding to the identifier of the first avatar registered in the second MP to be the second avatar when the identifier of the first avatar is registered in the second MP.

19. The electronic device of claim 12, wherein, the at least one instruction, when executed by the processor, causes the electronic device to determine the second avatar by changing an appearance of the first avatar in the second MP when the first avatar does not support synchronization in the second MP and an identifier of the first avatar is not registered in the second MP.

20. The electronic device of claim 12, wherein, the at least one instruction, when executed by the processor, causes the electronic device to determine the second avatar to be a default avatar provided by the second MP when the first avatar is not capable of being used in the second MP or a command to use another avatar in the second MP is received from a user.
